(19) United States
(12) Patent Application Publication
(10) Pub. No.: US 2004/0087471 A1
(43) Pub. Date: May 6, 2004

(54) Detergent composition and method for preparing alkali metal silicate granules

(76) Inventor: Theo Jan Osinga, Cadier en Keer (NL)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/475,690

(22) PCT Filed: Apr. 18, 2002
(86) PCT No.: PCT/EP02/04419

(30) Foreign Application Priority Data
Apr. 24, 2001 (EP) 01201492.4

(51) Int. Cl. C11D 3/02

(52) U.S. Cl. 510/511

(57) ABSTRACT

Detergent composition at least comprising a soluble alkali metal silicate, wherein the composition further comprises at least 0.01% by weight of calcium silicate, preferably up to 25% by weight and more preferably up to 10% by weight. Further the composition may comprise magnesium silicate or calcium carbonate or a combination thereof. Also methods for the preparation of silicate suspensions and silicate granules containing calcium silicate are described.

The present invention relates to detergent compositions at least comprising a soluble alkali metal silicate.

Detergent compositions known in the art apart from silicates generally contain surface active agents, builders, peroxide-type bleaching agents and a series of additives, e.g.: co-builders, additives to minimize deposition of precipitates on the heating coils of the washing machine or on the fibers of the wash-goods.

Further additives that are generally used are bleach promoters (e.g.: TAED), antire-deposition agents, preventing the re-deposition of soil, perfumes, fluorescing agents etc.

The soluble alkali metal silicates offer alkalinity in an effective manner and are also used as corrosion inhibitor, protecting metal parts in the washing machine as well as metal parts, present in the wash-good (buttons, zippers, etc.).

In practice detergent producers are confronted with the problem of deposition of various components on the wash-good as well as on the heating coils of the washing machine, during the washing operation. These deposits can have various sources, e.g.:

Re-deposition of soil. This can be due to insufficient dispersion of the soil.

Larger solid particles, present in the detergent product that are not dissolved during the washing procedure, can be “trapped” between the fibers of the wash-good and consequently are not rinsed out. These larger particles can either be insoluble detergent components or be due to poor dispersion or poor solubility of components.

Due to reactions between components present in the wash, precipitates can be formed. When these precipitates are present as dispersed small particles they may not cause a problem, as very small particles can be rinsed out. However, precipitation can also take place on fibers of the wash-good or on parts of the washing machine (e.g.: on heating coils). Residues on the wash-good is causing the so called “incrustation” and can be measured by the “ashing test”. In this test the wash-good is burned after a series of repeated washes and the weight of the remaining ash is compared with the weight of the ash obtained after burning new fibers of the same wash-good.

Ca and Mg ions present in hard water, used for the washing process, are a major cause for precipitation during the wash. These ions can form precipitates with carbonate, silicates, phosphates and many organic acids, incl.: fatty acids, present in soaps or formed during the washing process as a result of hydrolysis of fatty soil. White deposits form an increasing problem due to a trend towards colored fibers.

When precipitation takes place on the fiber surface, other components can be co-precipitated (trapped), causing the so-called graying or yellowing of the wash-good.

Another problem with which the detergent producers are confronted is related to bleaching. Various peroxide-bleach systems are used in the art. The most widely used systems are based on either per-borate or per-carbonate. Alleged environmental issues arose recently related to the use of per-borate. Therefore per-carbonate is the preferred system in the future.

Peroxide compounds have the tendency to decompose. Decomposition can take place in the detergent during storage as well as in the wash. Per-carbonate is more reactive than per-borate. The decomposition problem is increasingly important as per-borate is gradually being replaced by per-carbonate.

Decomposition during storage of per-oxy compounds in detergent powders is related to the humidity in the powder (in the pack). When the detergent powder is absolutely dry and when no water vapor can enter the pack, even the more reactive per-carbonate is stable.

Decomposition of per-oxy compounds during storage can be reduced by preventing direct contact between per-oxide (e.g.: per-carbonate) particles and other particles that contain free (mobile) water (e.g.: zeolite 4A and zeolite X). Coating of the per-carbonate particles also helps prevent the direct contact and consequently also improves storage stability. However water transport via the vapor phase still remains.

A better approach to solve the problem of decomposition during storage is to exclusively use detergent compounds that do not contain any free-mobile water and to also use desiccants that pick up water vapor entering the pack. Zeolite MAP, a P-type zeolite, offered by the firm INEOS-Silicas is ideal in this respect, not containing free-mobile water and also acting as a desiccant.

Soluble silicates, present in many detergent products (e.g.: as powders or in granular form), also offer a contribution to the desired desiccant function.

Decomposition of per-oxy compounds during the washing process is caused by a catalytic reaction, promoted by several (heavy-) metal ions (e.g.: copper, manganese, titanium, etc.). Decomposed per-oxy molecules are not available any more for the bleaching process and thus reduce the effectiveness of the bleaching system.

Detergent producers approach this problem in various manners: Excess amounts of bleach components are used in the formulations or agents are added that bind and inactivate the heavy-metal ions. Binding of (heavy-) metal ions can be realized by adding complex forming agents, e.g.: EDTA, phosphonates etc. Alternatively soluble silicates can be added, which form insoluble heavy-metal silicates. Complex forming agents are increasingly under pressure, due to safety and environmental issues related to their use. Therefore the use of silicate for this application is of growing interest. Silicate ions are successful in binding several heavy-metal ions, e.g.: copper and manganese ions. Soluble silicates generally contain titanium and iron ions, of which titanium is also catalytically active in the decomposition reaction of per-oxy compounds. Titanium is not effectively de-activated by silicate ions.

Furthermore, silicate ions cause precipitates of calcium silicates and to a much lesser extent of magnesium silicates. Calcium silicate can form deposits on the fabrics and on the heating coils of the washing machine. In the presence of heavy metal ions, these metal ions can be co-precipitated (trapped) with the Ca-silicate on the fabric surface. The presence of catalytically active metal ions on the fabric surface can locally lead to a higher catalytic oxidation activity on this fiber surface. In extreme cases, this can cause damage to dyes or even to fibers.

The detergent industry has actively been searching for solutions to minimize the formation of deposits on the surfaces of fibers or on the heating coils of the machine when using soluble silicates.

The first solution was to use the well known builders which bind calcium and magnesium ions by keeping these ions in solution using complex forming agents (e.g.: sodium-tri-phosphate, NTA, citrates etc.) or by binding the calcium and magnesium ions in small particles (zeolite 4A, zeolite X, zeolite MAP or crystalline sodium-silicate). These builders were effective in binding Ca or Mg ions, but none of them completely solved the problem.

Sodium-ti-phosphate slowly decomposes in aqueous media, forming phosphate ions, which form highly insoluble calcium phosphate precipitates. These precipitates even contribute to the deposit formation on fibers and machine parts.

NTA is banned in most countries for general use, due to environmental issues related to its use.

Citrate is not binding calcium strong enough, leaving a relatively high calcium concentration in solution, still allowing precipitation of insoluble calcium salts.

Zeolite 4A, zeolite X and the most efficient zeolite MAP bind calcium ions by exchange of sodium ions, present in the zeolites. Magnesium ions are bound less efficiently. The residual calcium ion concentration in solution is determined by the exchange equilibrium of the specific zeolite for sodium ions and calcium ions. Even when an excess of zeolite is present in the wash, the residual calcium concentration in solution will still be at a level comparable to the equilibrium calcium concentration for calcium-silicate. Therefore calcium-silicate formation can not be completely avoided. Zeolite MAP having by far the lowest equilibrium calcium concentration is superior in calcium binding. Zeolites are also relatively slow in binding calcium ions. This means, that precipitation of insoluble calcium salts (e.g.: calcium-silicate) can take place during the first minutes of the wash process, as long as the zeolite has not yet reached its equilibrium calcium concentration.

Crystalline sodium silicates were first introduced by the German firm Hoechst as another alternative to phosphate. These crystalline silicates were produced by heating precipitated amorphous sodium silicates with a molar ratio SiO₂/Na₂O of above 1.5 at a temperature above 400° C. The crystalline silicates, thus obtained, have a layered structure and function in the same way as zeolites, exchanging sodium present in the crystalline silicate by calcium and magnesium ions. With respect to binding of calcium and magnesium these crystalline silicates have the same limitation as zeolites, still allowing precipitation of calcium salts during the first minutes of the wash process, including calcium silicate when besides the crystalline silicate also soluble silicate is present. These crystalline silicates with molar ratios SiO₂/Na₂O of above 1.5 have an extremely poor solubility and therefore are not falling under the heading soluble silicates.

Several organic compounds can be further used as complex-forming agents for calcium ions, but are either too costly to be used as main builder or not sufficiently effective. Organic compounds also add to the oxygen demand when ending in the surface waters (BOD) while others are not completely biodegradable.

Organic compounds are generally used as co-builder in combination with a main builder like STP or zeolite (4A, X or MAP). Well-known co-builders are polysaccharides and co-polymers of acrylic acid and maleic acid.

Sodium carbonate and/or sodium silicates bind calcium and magnesium ions and are used as builders. However as these builders function by forming insoluble salts, i.e.: calcium and magnesium carbonates slowly and with a delay in the form of very small dispersed particles and/or calcium and magnesium silicates, which do not only form dispersed small particles, but also tend to precipitate on the various surfaces, these builders are inferior to zeolites and tri-phosphate.

Sodium carbonates (incl. sodium bicarbonate and sodium sesquicarbonate), which seemed the most suitable soluble salts, as they do not tend to precipitate on fiber surfaces, forming very finely dispersed precipitates of calcium and magnesium carbonate were extensively studied around 1970 as alternative “Builder”, when an alternative for phosphate had to be found. A major problem related to the use of carbonate being however, that the reaction between carbonate and the free metal ions (Ca and Mg) is relatively slow, even having an initiation phase. As a result the Ca and Mg ions react with organic components present in the wash, e.g.: surfactants and soil. This reaction with surfactants leads to a reduced surfactant action i.e.: worse detergency and the reaction with the soil can lead to worse removal of soil.

It was reported in U.S. Pat. No. 1,460,646, U.S. Pat. No. 3,997,692 and NL 7305925 that addition of seeds for the precipitation reaction increased the speed of the reaction between the anion of the soluble salt (i.e.: carbonate) and the free Ca and Mg ions, thus reducing the time available for the Ca and Mg ions to react with the organic compounds. Although in these patents it was mentioned, that many combinations of salts with seeds were suitable and that the choice of seed did not have to be related to the salt, the only seeds tested and found to be successful were calcium carbonate or its precursors calcium oxide and calcium hydroxide.

Calcium carbonate seeds hardly enhance the speed of calcium silicate formation in case soluble silicate is incorporated in the detergent formulation. In fact calcium silicate formation obtained from the reaction of silicate ions with calcium and to a lesser extent with magnesium ions is already fast and without an initiation phase.

In case carbonate ions are present next to silicate ions no noticeable effect on calcium silicate precipitation on fiber surfaces or metal surfaces can be found as well.

As the problems connected to the use of soluble salts like carbonate (too slow) and/or silicate (incrustation) as main “builder” could not be solved to complete satisfaction, carbonate was only applied in cheap, lower grade formulations or in areas where water of very low hardness was available e.g. in Indonesia.

There have been several further attempts to reduce precipitation on the various surfaces, e.g. on fabric-fibers. Additives were advised that increase the soil carrying properties of the liquor and reduce the tendency of the surfaces of the fibers to act as nucleus for precipitation. It was found, that different additives were needed for different types of surface.

The following German Patents describe a series of additives that can be applied: 2054097; 2165835; 2165898; 2165900; 2165804; 2165803; 2165834. The additives advised were mainly polymers with anionic groups, e.g.: cellulose and derivatives thereof as well as poly-acrylates, poly-metacrylates, poly-maleates and their co-polymers. It was reported in these patents, that cellulose type additives (preferably CMC) were effective for cotton, but practically ineffective for synthetic fibers, while several synthetic polymers (preferably PVP) are effective for synthetic fibers. Although these additives reduce deposit formation, some deposit is still formed.

More recently a series of new attempts have been made to optimize the performance of sodium-carbonate and soluble sodium-silicate as main builder or at least as co-builder in combination with STP or with zeolite. (GP: 4406592A1; 4415362A1; 4442977A1; 4400024A1; 19509303A1; 19601840A1; 19611012A1; 19710383A1; 19709411A1; 19843773A1 and U.S. Pat. No. 6,013,617). In these patents it is either proposed to control (reduce) the dissolution rate of the silicate or to form specific polymeric silicate species, that are claimed to be more efficient in binding calcium and magnesium. These patents clearly show, that although some reduction in deposition of residues was demonstrated, residue formation still takes place.

The object of the present invention is to provide a solution to the problems as mentioned above relating to the deposition of various components during the washing process.

To that end the invention is characterized in that the detergent composition further comprises at least 0.01% by weight of a compound selected from the group consisting of amorphous calcium silicate and amorphous magnesium silicate, or a mixture thereof, based on the soluble alkali metal silicate. Preferably, at least amorphous calcium silicate is used.

It has now unexpectedly been found, that addition of, preferably synthetically produced, amorphous calcium silicate and/or amorphous magnesium silicate to the wash further assists in preventing the formation of deposits. Amorphous calcium and/or magnesium silicate can be added separately to the detergent formulation.

The person skilled in the art will readily understand what is meant by ‘amorphous’. Preferably, the amorphous calcium and/or magnesium silicate has not been heated above 120° C.

The detergent composition according to the invention is not limited to granular detergents, but also encompasses liquid detergent compositions, detergent gels, detergent tablets and the like.

Advantageously the composition comprises up to 25% by weight, preferably up to 10% by weight, more preferably up to 5% by weight, most preferably up to 3% by weight of amorphous calcium silicate, amorphous magnesium silicate or a mixture thereof, based on the soluble alkali metal silicate. More preferably the composition comprises 0.1 to 3% by weight of amorphous calcium silicate and/or amorphous magnesium silicate.

In a particular embodiment of the present invention the composition further comprises amorphous magnesium silicate or calcium carbonate or a combination thereof. Preferably these are present in an amount of up to 5% by weight either separately or in combination.

The particle size of the amorphous calcium silicate present in the detergent composition according to the invention is not specifically limited. Preferably however the amorphous calcium silicate is present as fine particles, at least 95 percent by weight of the particles having a particle size below 40 micrometer, preferably more than 90 percent by weight of the particles having a particle size below 15 micrometer, more preferably more than 90 percent by weight of the particles having a particle size of below 5 micrometer and most preferably more than 80% by weight of the particles having a particle size of below 0.2 micrometer.

Soluble silicates are alkali-metal (e.g.: sodium, potassium, lithium) silicates. For detergent applications sodium silicate is generally preferred for economic reasons, while potassium is used in some special applications. Soluble sodium silicates and potassium silicates can be supplied as aqueous solutions but also as dried powders or in granular forms.

Other components can be added to soluble silicate solutions before drying (e.g.; citrate salts, polymers or co-polymers of acrylic acid and maleic acid, PVP, sodium carbonate, sodium sulfate, surface active agents, textile softeners etc.). The silicate based “compounds” thus formed in powder form can also be granulated or compacted to form granules. Drying can preferably take place in a spray-tower or in a “turbo-dryer” as offered by the Italian firm VOMM (Milan).

For detergent products, produced by a spray-drying process, soluble silicates are generally introduced as aqueous solutions added to the detergent slurry before spray-drying. Silicates have an additional beneficial function in spray-dried detergent powders, i.e.: it helps securing a good, free-flowing powder structure. Silicates can alternatively be post-dosed as powder or in granular form to spray-dried powders. Silicate based “compounds” can also be added as powder or in granular form. Detergent powders can be further processed according to various techniques known in the art, thus forming “compacts”, extrudates or tablets.

Detergent products in solid form are alternatively produced by various dry-mixing operations in which several solid components are mixed. Liquid components can be added to the dry powder mix (e.g. surface active agents), which have to be absorbed or adsorbed by the dry components in order to secure good powder flow properties. Often these liquid components are already adsorbed, absorbed or trapped by one or more solid components (“compounds”) before being mixed with the other solid detergent components.

Soluble silicates can be added to the dry-mixing operation as powder or in granular form. The silicate can also be added as silicate based “compound”.

Amorphous calcium silicate can be incorporated in a spray-dried detergent in various manners, e.g.: It can be added as fine powder to the detergent slurry before spray-drying. Amorphous calcium silicate can also be post dosed to the spray dried powder.

Amorphous calcium silicate powder can also be present in the silicate liquor in a finely dispersed form or preferably as a sol.

In case detergent powders are produced in a dry-mix process, calcium silicate can be dosed to the detergent mix in powder form. In a preferred form of the invention, the amorphous calcium silicate is incorporated in the dry soluble silicate. Calcium silicate can be dispersed as fine powder in the soluble silicate liquor before drying. It is preferred to precipitate the calcium silicate in the aqueous solution of the soluble silicate by adding an aqueous solution of a soluble calcium salt (e.g.: calcium chloride) to the silicate liquor.

This suspension of calcium silicate in an aqueous soluble silicate solution is dried to form a powder.

The ratio between calcium and silicate should preferably be such, that less than 50% of the silicate is precipitated by the calcium ions. More preferably less than 25% of the silicate is transferred into calcium silicate and most preferably less than 10% of the silicate is transferred into calcium silicate.

The present invention further provides a method for the preparation of silicate granules at least comprising the step of drying an alkali metal silicate liquor to a suitable water content, characterized in that before drying a suitable amount of calcium silicate, calcium hydroxide or a soluble calcium salt is added to the silicate solution.

The present invention furthermore provides a method for the preparation of a silicate sol, containing small amorphous calcium silicate and/or amorphous magnesium silicate sol particles, at least 95 percent by weight of the particles having a particle size below 40 micrometer, preferably more than 90 percent by weight of the particles having a particle size below 15 micrometer, more preferably more than 90 percent by weight of the particles having a particle size of below 5 micrometer and most preferably more than 80% by weight of the particles having a particle size of below 0.2 micrometer, wherein the method comprises the step of providing a concentrated aqueous alkali metal silicate liquor, having a molar ratio SiO₂/M₂O above 1.2 and preferably above 1.6, M being selected from the group consisting of sodium and potassium or a mixture thereof, wherein a suitable amount of a soluble calcium or magnesium salt, an aqueous solution of a calcium or magnesium salt or calcium or magnesium hydroxide is added to the silicate solution.

The present invention also provides a method for the preparation of silicate granules at least comprising the step of drying of an alkali metal silicate liquor to a suitable water content, characterized in that before drying a suitable amount of calcium silicate, calcium hydroxide, a soluble calcium salt, an aqueous solution of a calcium salt, magnesium silicate, magnesium hydroxide, a soluble magnesium salt or an aqueous solution of a magnesium salt is added to the silicate liquor.

In the above three methods for the preparation of a silicate suspension, silicate sol and silicate granules, with ‘suitable amount’ such an amount is meant that the composition comprises up to 25% by weight, preferably up to 10% by weight, more preferably up to 5% by weight, most preferably up to 3% by weight of amorphous calcium silicate or magnesium silicate, based on the soluble alkali metal silicate.

In the previous three methods apart from the calcium compounds also other compounds may be added, such as e.g. amorphous magnesium silicate, a soluble magnesium salt etc.

The term ‘liquor’ encompasses solutions, suspensions dispersions, sols etc.

Advantageously the granules are milled to a powder having a particle size of below 2000 micrometer, preferably 90 percent by weight of the powder having a particle size of below 800 micrometer and most preferably having 90 percent by weight of the powder having a particle size of below 600 micrometer.

Preferably the powder formed is granulated or compacted (e.g.: in a roller-compacter) to form larger and more dense granules.

More preferably the granules obtained are milled and sieved to a suitable particle 20 size, preferably between 25 and 1200 micrometer, more preferably 90 percent by weight of the granules having a particle size of between 25 and 800 micrometer and most preferably 90 percent by weight of the granules having a particle size of between 50 and 600 micrometer.

Further the invention provides silicate suspensions obtainable by the method according to the invention.

Also the invention provides silicate sols obtainable by the method according to the invention.

Still further the invention provides silicate granules obtainable by the method according to the invention.

Even further the invention provides the use of silicate granules according to the invention for the preparation of a detergent composition.

Finally, the invention provides the use of the silicate suspersion or silicate sol in a bleaching process for paper, wool, cotton or other textile fibers.

It is furthermore possible to add other components to the suspension of amorphous calcium silicate in soluble silicate before drying (e.g.; citrate, polymers or copolymers of acrylic acid and maleic acid, PVP, sodium carbonate, sodium sulfate, surface active agents, textile softeners etc.) forming the so-called “compounds”. These compounds in powder form can also be granulated or compacted producing the “compounds” in granular form.

There are several benefits related to the addition of the calcium silicate in the soluble silicate liquor used in detergents either as liquor or as powder or in granular form.

Although applicant does not wish to limit himself to any specific theory, the invention resides in that addition of amorphous calcium silicate to a detergent product containing soluble silicate helps prevent deposition on the surfaces of fibers and machine parts, which could be explained by assuming, that the surface of amorphous calcium silicate forms a superior nucleus for the precipitation of calcium salts (e.g.: calcium silicate) than a fiber surface or a metal surface.

Calcium silicate is the main precipitate causing incrustation even when both silicates and carbonates are present in the wash. It was found, that calcium silicate is also by far a superior nucleus for the capturing of calcium silicate and thus minimizing incrustation than other known seeds like calcium carbonate, which apparently are not more effective nuclei for calcium silicate than the fiber surfaces or the metal surfaces present. Although calcium carbonate is known to increase precipitation rates of calcium carbonates, it is surprisingly not successful in preventing precipitation of calcium silicates on fibers and metal surfaces.

Therefore precipitation of insoluble calcium salts, mainly responsible for incrustation, is preferential on the amorphous calcium silicate surface. Homogeneous suspensions of amorphous calcium silicate in a soluble silicate solution secure the closest proximity between calcium silicate surface and silicate ions in solution, minimizing the risk of silicate precipitation on other surfaces.

Amorphous calcium silicate surfaces present in soluble silicate suspensions are covered by (reactive) silicate ions, which further promote the precipitation of metal silicates on that surface.

During the production of the calcium silicate in the soluble silicate solution, other metal ions (e.g.: titanium) can be enclosed (trapped) in the calcium silicate formed. This helps to improve the stability of per-oxy bleach components in the wash (e.g.: per-carbonate) when applied in combination with soluble silicates. It was observed, that replacing part of the calcium ions by magnesium ions has a further beneficial effect on the stability of per-oxy bleach systems in the wash.

It is preferred to apply the products according to this invention in combination with other systems advised to reduce the formation of residues, and to reduce the problems of incrustation, graying and yellowing related to deposits on fabric surfaces.

In a specially preferred system amorphous calcium silicate and soluble silicate are used in combination with one or more builders (STP, crystalline sodium silicate, zeolite 4A, X or preferably MAP) and optionally also a co-builder (e.g.: co-polymers of acrylic and maleic acid or polysaccharide).

It is possible to also use additives like CMC, derivatives of CMC and PVP to reduce the tendency of fiber surfaces to act as nucleus for precipitation.

Preferred soluble silicates are sodium silicate and potassium silicate. For economic reasons sodium silicate is generally most preferred. Potassium silicate is used in liquid detergent products or in combination with sodium silicate to improve solubility (e.g. max. 10% by weight of potassium silicate).

Soluble silicates are characterized by their Molar Ratio: SiO₂/M₂O (M=alkali metal).

The molar ratio determines the alkalinity of the soluble silicate and consequently its safety classification. Safety classification determines the maximum amount of soluble silicate that can be tolerated in the detergent product allowing the detergent product to be classified as safe. There is a trend in the market towards sodium per-carbonate as bleach component being also alkaline. Sodium carbonate formed from the per-carbonate is also alkaline. As the per-carbonate and the carbonate are both classified as unsafe based on the alkalinity, there is an increasing pressure to make other detergent components safer (less alkaline) in order to stay below the limits set for safety classification of the total detergent product.

Consequently there is a demand for increasing the safety of soluble silicates, which means that there is a trend towards higher molar ratios. For fabric washing, silicates with molar ratios SiO₂/Na₂O of 2.0 and 2.4 (classification: highly irritant) were generally used. Nowadays, molar ratios above 2.6 (slightly irritant) and even above 3.3 (safe) are preferred. However the solubility of soluble silicates is reduced by increasing the molar ratio. Therefore several measures are taken to optimize the solubility of silicates, thus allowing higher molar ratios at reasonable solubility.

The solubility of soluble silicate powders and granules can be improved by minimizing the particle size or by adding other soluble salts to the silicate liquor before drying. Examples of suitable soluble salts are: sodium carbonate, sodium sulfate, sodium citrate. Also the corresponding potassium salts and potassium silicate can be used.

Addition of other salts has a further beneficial effect on the hygroscopic properties of solid silicates and consequently also on the caking during storage.

In general the particle size of soluble silicates with higher molar ratios should preferably not exceed 1 mm, preferably 90 wt. % of the particles should have a particle size of below 800 micrometer and most preferably 90 wt. % of the particles should have a particle size of below 600 micrometer.

Detergent products containing soluble silicate and amorphous calcium silicate can furthermore contain all known detergent components in suitable amounts, e.g.:

Zeolite builders, e.g.: zeolite 4A, zeolite X or preferably zeolite MAP

Other builders, e.g.: crystalline sodium silicates with a layered structure, sodium tri-phosphate (STP), sodium citrate

Co-builders, e.g.: polysaccharides, co-polymers of acrylic acid and maleic acid

Surface active agents of the anionic type, of the nonionic type or of the cationic type

Bleaching agents, e.g.: per-borate, per-carbonate

Bleach activators, e.g.: TAED

Anti re-deposition agents, e.g. derivatives of cellulose (e.g.: CMC), PVP and other synthetic polymers

Fluorescing agents

Perfumes

Fabric-softeners

Finally it is noted that the present invention provides excellent results when applied to among others bleaching processes of paper, wool and raw textiles. To this end the silicate granules or the silicate liquor comprising the calcium compound and/or the magnesium compound, i.e. amorphous calcium silicate and/or amorphous magnesium silicate, can be added to the bleaching liquid.

### EXAMPLES

Materials used:

A. Concentrated aqueous solution of sodium silicate [obtained from the firm Ineossilicas, Eijsden, The Netherlands].

| | | | |
|---|---|---|---|
| Dry solid content: | 45 | Fe (ppm on dry wt. basis): | 88 |
| SiO₂ content: | 29.7% | Ti (ppm on dry wt. basis): | 77 |
| Na₂O content: | 15.3% | Density: | 1460 |
| | g/l. | | |
| Molar ratio SiO₂/Na₂O | 2.0 cP. | Viscosity: | 90 |

B. Concentrated aqueous solution of calcium chloride [obtained by dissolving CaCl₂.2H₂O in demineralized water].

CaCl₂. Content: 24.42 %

### Example 1

### Preparation of Colloidal Solutions of Calcium Silicate in Concentrated Aqueous Sodium Silicate Solutions

A sodium silicate solution (material A) was introduced into a 250 ml beaker glass. A calcium chloride solution (material B) was added under magnetic stirring. Dosing of material B was carried out gradually in approx. 5 minutes by means of a 20 ml syringe.

| | Material A | Material B | | Theoretical | Theoretical |
|---|---|---|---|---|---|
| | 45 wt. % | 24.42 wt. % | | CaO.SiO₂*) | CaO.SiO₂*) |
| Test | Na-Sil | CaCl₂ | Temp. | Formed | Concentration |
| nr. | g | g | ° C. | g | Wt. % |
| P1 | 197 | 10 | 25 | 2.56 | 1.24 |
| P2 | 196 | 4.3 | 25 | 1.10 | 0.50 |
| P3 | 268 | 13 | 80 | 3.32 | 1.18 |
| P4 | 201 | 10 | 80 | 2.56 | 1.21 |

*)Theoretical CaO.SiO₂ is the amount of calcium silicate theoretically formed, assuming that all calcium dosed is reacting with silicate forming calcium silicate and that n in the formula CaO.nSiO₂ is 1.0.

Results:

Examples P1-P4 produced poor non-homogeneous suspensions visibly containing a gel, floating in the silicate liquor. This gel was even formed in Experiment P2, having a very low concentration of the theoretical CaO.SiO₂. Examples P3 and P4 carried out at 80° C. produced suspensions with less visible gel, indicating, that higher temperatures were to be preferred.

### Example 2

### Preparation of Colloidal Solutions or Sols of Calcium Silicate in Concentrated Aqueous Sodium Silicate Solutions

A sodium silicate solution (material A) was introduced into a beaker-glass of 1000 ml and heated to 80° C. A calcium chloride solution (material B) was added under intensive stirring, using a rotary mixer. Dosing of B was at a constant rate within 8 to 10 minutes in a controlled manner from a burette keeping the temperature constant. When the dosing was finished, the mixer was removed and the heating was turned off. The beaker-glass was covered by a shrunk plastic foil and left to cool down. The conditions were as follows:

| | Material A | Material B | | | | Theoretical | Theoretical |
|---|---|---|---|---|---|---|---|
| | 45 wt. % | 24.42 wt. % | | | Dosing | CaO.SiO₂ *) | CaO.SiO₂ *) |
| | Na-sil. | CaClₛ | Temp. | Stirring | Time | Formed | Concentration |
| Test Nr. | g | g | ° C. | RPM | Min. | g | Wt. % |
| P5 | 846 | 42.3 | 80 | 800 | 10 | 10.81 | 1.22 |
| P6 | 850 | 42.5 | 80 | 1000 | 8 | 10.86 | 1.22 |

Example P6 was repeated 10 times.
*) Theoretical CaO.SiO₂ is the amount of calcium silicate theoretically formed, assuming that all calcium dosed is reacting with silicate forming calcium silicate and that x in the formula CaO.nSiO₂ is 1.0.

Results of Example 2:

Surprisingly the solutions remained practically clear during the dosing of the calcium chloride and even when stored during several months, only a trace of turbidity could be observed. Results were also found to be well reproducible.

Discussion Examples P5 and P6.

Gel formation was avoided by simultaneously increasing the dosing time of calcium chloride as well as the stirring intensity at an elevated temperature. Conditions were apparently found where the calcium silicate formed is present as a stable sol in the concentrated silicate liquor.

### Example 3

Scaling Experiments

The influence of the presence of small quantities of calcium silicate during the addition of silicate to hard water on scaling on stainless steel surfaces of heating coils was investigated. This is a known quick test as also described by the firm Henkel in DE 44 15 362, being relevant to scaling taking place on metal surfaces in washing machines as well as to scaling taking place on the metal parts in paper mills and textile factories during peroxide bleaching, but also to incrustation on fabric fibers, caused by calcium silicate.

Test procedure for assessment of scaling, caused by calcium silicate precipitation Five liters of hard water of 30° GH (Ca: Mg=5:1) are introduced in a stainless steel vessel equipped with a magnetic stirrer and with a heating coil (Prospec (Emergo) 1000 W type 105). Silicate (8.35 g or 16.7 g on a dry basis) is added either as a liquor or in powder form or in granular form, while stirring. The vessel is heated to 90° C. in 30 minutes by means of the heating coil and kept at this temperature for another 30 minutes. Subsequently the coil is removed and placed in 5 1 cold water (30° GH during 5 minutes). This procedure is repeated another 4 times. The coil is then rinsed and dried. Scaling on the coil is first visually assessed using a scale of 0-10 (0=no scaling, 10=very high scaling level). The precipitated calcium silicate is removed from the coil by treatment with 800 ml citric acid at 80° C. during 1 hr and subsequent addition of 800 ml of an aqueous solution containing NaOH (2.2 wt. %) and NTA (0.125 wt. %). After 30 minutes, the coil is finally rinsed with demineralized water. The liquor obtained containing the dissolved calcium silicate is then transferred into an 1 l volumetric flask. The calcium concentration is measured according to a standard analytical technique (e.g.: ECP-OES). From this concentration the amount of calcium silicate on the coil is calculated and expressed as amount of CaO.SiO₂, assuming, that the molar ratio in the calcium silicate is 1.0.

Scaling Experiments Carried Out

In the scaling tests according to above procedure pure silicate solution (Material A) was used as well as a calcium silicate containing silicate solution, in which the calcium silicate was present as a sol (sample P6 from Example 2).

Scaling results

| | Silicate | Silicate | | Scaling | Scaling |
|---|---|---|---|---|---|
| Exper. | Liquor | g. | Coil | Visual | Mg. |
| Nr. | Added | (100% dry basis) | Nr. | (0-10) | CaO.SiO₂ |
| Sc1 | A | 16.7 | 1 | 5 | 83 |
| Sc2 | A | 16.7 | 1 | 7 | 81 |
| Sc3 | A | 16.7 | 1 | 5 | 124 |
| Sc4 | A | 8.35 | 1 | 5 | 46 |
| Sc5 | P6 | 8.35 | 1 | 1 | 6 |
| Sc6 | P6 | 8.35 | 1 | 1 | 6 |
| Sc7 | P6 | 8.35 | 1 | 1 | 6 |
| Sc8 | A | 8.35 | 2 | 5 | 89 |

These tests clearly demonstrate the positive effect of the presence of calcium silicate on calcium silicate scaling. An interesting observation was made during these experiments, i.e.: The diluted silicate liquors obtained after this test using pure silicate (solution A) were turbid, while the diluted liquors obtained after the tests using silicate with calcium silicate (P6) remained practically clear. This also demonstrates, that the calcium silicate, present as small sol particles captures the calcium silicate produced during the test, while calcium silicate that is formed in the absence of calcium silicate precipitates at random in the liquor (creating turbidity) as well as partially on the metal surface. In separate tests, it was found that the presence of sodium carbonate in this scaling test (up to 50 wt. % sodium carbonate relative to sodium silicate on a dry weight basis) had no noticeable effect on the scaling of calcium silicate.

### Example 4

Analysis of the calcium silicate present in the sodium silicate liquors obtained in EXAMPLE 2.

Procedure

It was tried to separate calcium silicate formed in EXAMPLE 2 by filtration and centrifugation. This was not possible due to the colloidal nature of the calcium silicate sol formed in EXAMPLE 2. It was found however that it was possible to create a partial sol-gel transfer reaction by diluting the liquors obtained in the repeated tests carried out in P6 (EXAMPLE 2) with an equal weight of demineralized water and subsequent heating to 70° C. By subsequent centrifugation and filtration only 8-12 wt. % of the theoretically formed calcium silicate could be obtained in solid form. The remaining part apparently still being present in colloidal form. The small amounts of solid calcium silicate, thus obtained, was washed and dried. Following components were analyzed in the dry solid: Ca, Si, Ti and Fe and an XRD analysis was made.

Results.

1: Ca and Si

Ca and Si analyses showed, that the solid consisted of CaO.nSiO₂ in which the n varied between 0.8 and 1.4. Although repeated analyses (10 times) indicated an average for n of 1.2, a value of 1 was adopted in the tables above.

2: XRD

XRD showed the calcium silicate to be amorphous or present as micro-crystallites, that are so small, that no XRD lines were found. It was concluded, that the calcium silicate was XRD-amorphous.

3: Ti and Fe

Fe and Ti analysis showed, that approx. 8-12 wt. % of the Fe and Ti that was originally present in the silicate liquor (Material A) was removed during the formation of the calcium silicate that could be separated from the sols of P6. As the quantity of calcium silicate that could be separated from the sols was only 8-12 wt. % of the theoretically present calcium silicate in the sols, this indicates, that the small calcium silicate particles formed in EXAMPLES 1 and 2 are successfully incorporating the Ti and Fe ions from the original silicate solutions at least for the larger part, thus removing these ions from the original solution. From this it can be concluded, that the precipitation of calcium silicate in a sodium silicate solution will have a strong beneficial effect on the stability of peroxide bleaching systems in the wash and on preventing a damaging peroxide reaction with textile fibers and colors/pigments, when such a silicate is used, due to the reduction in free Ti and Fe levels.

### Example 5

The adsorption or entrapment of titanium and iron during the production of the calcium silicate sols and magnesium silicate sols and the observation, that in Example 3 using a sol, clear solutions were obtained, which were reduced in color when carried out in the presence of a dye, while the precipitate was then colored, demonstrate, that the sols will also adsorb or entrap other components present in the wash, e.g. soil and dyes, thus supporting prevention of redeposition of soil and dye transfer.

As experimental evidence the following experiment was performed. Start with 1 l. cold hard water (30 degree German Hardness) in a glass flask, add 2 pieces of standard black cloth (5×5 cm.) and then introduce quickly by syringe either 7.6 g. silicate sol (7.6 g. as such) or pure silicate liquor and shake gently 10 times.

Remove the clothes after 10 minutes and rinse with distilled water and then optically assess the appearance of the clothes

It could be observed, that the cloths obtained using the sol still were shiny black, while the cloths obtained with pure silicate already lost some shine, due to a matting effect caused by precipitation on the cloth.

This indicates also, that the use of sols help prevent incrustation.

1. Detergent composition at least comprising a soluble alkali metal silicate, wherein the composition further comprises at least 0.01% by weight of a compound selected from the group consisting of amorphous calcium silicate and amorphous magnesium silicate, or a mixture thereof, based on the soluble alkali metal silicate.

2. Detergent composition according to claim 1, wherein the composition comprises up to 25% by weight of amorphous calcium silicate, amorphous magnesium silicate or a mixture of thereof, based on the soluble alkali metal silicate.

3. Detergent composition according to claim 1, wherein the composition further comprises calcium carbonate.

4. Detergent composition according to claim 1, wherein the amorphous calcium silicate and/or amorphous magnesium silicate is present as fine particles, at least 95 percent by weight of the particles having a particle size below 40 micrometer.

5. Detergent composition according to claim 1, wherein the composition is a composition selected from the group consisting of a powder, granules, a sol, a dried sol, preferably a sol or a dried sol.

6. Method for the preparation of a silicate suspension at least comprising the step of providing an aqueous alkali metal silicate liquor, wherein a suitable amount of calcium silicate, calcium hydroxide, a soluble calcium salt, magnesium silicate, magnesium hydroxide, or a soluble magnesium salt is added.

7. Method according to claim 6, wherein the method comprises the further step of drying the silicate suspension.

8. Method for the preparation of a silicate sol, containing small amorphous calcium silicate and/or amorphous magnesium silicate sol particles, at least 95 percent by weight of the particles having a particle size below 40 micrometer, wherein the method comprises the step of providing a concentrated aqueous alkali metal silicate liquor, having a molar ratio SiO₂/M₂O above 1.2, M being selected from the group consisting of sodium and potassium or a mixture thereof, wherein a suitable amount of a soluble calcium or magnesium salt, an aqueous solution of a calcium or magnesium salt or calcium or magnesium hydroxide is added to the silicate solution.

9. Method according to claim 8, wherein the method comprises the further step of drying the silicate sol.

10. Method for the preparation of silicate granules at least comprising the step of drying an alkali metal silicate liquor to a suitable water content, wherein before drying a suitable amount of calcium silicate, calcium hydroxide, a soluble calcium salt, an aqueous solution of a calcium salt, magnesium silicate, magnesium hydroxide, a soluble magnesium salt or an aqueous solution of a magnesium salt is added to the silicate solution.

11. Method according to claim 10, wherein the granules are milled to a powder having a particle size below 2000 micrometer.

12. Method according to claim 11, wherein the powder formed is granulated or compacted to form larger and more dense granules.

13. Method according to claim 12, wherein the granules obtained are milled and sieved to a suitable particle size of between 25 and 1200 micrometer.

14. Silicate suspension obtainable by the method according to claim 6.

15. Use of the silicate suspension according to claim 14 in a bleaching process for paper, wool, cotton or other textile fibers.

16. Silicate sol, preferably a dried silicate sol, obtainable by the method according to claim 8.

17. Use of the silicate sol according to claim 16 in a bleaching process for paper, wool, cotton or other textile fibers.

18. Silicate granules obtainable by the method according to claim 10.

19. Use of silicate granules according to claim 18 in a bleaching process for paper, wool, cotton or other textile fibers.

20. Use of the silicate suspension according to claim 14, the silicate sol according to claim 16 or the silicate granules according to claim 18 for the preparation of a detergent composition.
